(19) United States
(12) Patent Application Publication
(10) Pub. No.: US 2024/0308453 A1
(43) Pub. Date: Sep. 19, 2024

(54) Method and Apparatus of Intelligent Charging Control for Automotive Battery

(71) Applicant: TOPDON TECHNOLOGY Co., Ltd., Shenzhen (CN)

(72) Inventors: Zhenbin Zhou, Shenzhen (CN); Ke Lou, Shenzhen (CN); Kaijun Zhou, Shenzhen (CN); Fusen Liu, Shenzhen (CN); Peng Fan, Shenzhen (CN)

(21) Appl. No.: 18/232,838

(22) Filed: Aug. 11, 2023

(30) Foreign Application Priority Data
Mar. 16, 2023 (CN) 202310253909.7

(51) Int. Cl. B60R 16/033; H02J 7/00

(52) U.S. Cl. CPC B60R 16/033; H02J 7/0047; H02J 7/00712

(57) ABSTRACT

Disclosed in the present application is a method and apparatus of intelligent charging control for an automotive battery, the method including: identifying a battery parameter of the automotive battery to be charged; identifying a charging mode based on the battery parameter; identifying a present electrical parameter, and identifying the charging phase based on the present electrical parameter; and identifying a target charging control parameter of the charging phase based on the charging phase of the charging mode, and performing a charging control operation on the automotive battery based on the target charging control parameter. In such a setup, it may improve the charging matching between the charger and the battery, and improve the charging accuracy of the battery, so that the occurrence of the battery being undercharged or float charging is decreased, thereby improving the charging performance of the battery to ensure a normal operation of a car.

### CROSS REFERENCE TO RELATED APPLICATIONS

The present application claims the benefit of Chinese Patent Application No. 202310253909.7 filed on Mar. 16, 2023, the contents of which are incorporated herein by reference in their entirety.

### FIELD OF THE INVENTION

The present application relates to the technical field of automotive batteries, in particular to a method and apparatus of intelligent charging control for an automotive battery.

### BACKGROUND OF THE INVENTION

As the core component of the fuel car, the main role of the battery is to provide power to the electrical equipment on a car as well as to supply power to the starter and ignition system when the car is ignited and started. Therefore, the power supply capacity of the battery directly affects the performance of the car, thus affecting the normal operation of the car.

Currently, the charging method for the battery is generally achieved by starting the internal combustion engine to drive the generator to generate electricity and charge the battery by the generator, or by using an additional charger to charge the battery after the car stops running. However, it is found in practice that the current charging method of the charger provides a single function, which is difficult to be compatible with the batteries of various vehicle specifications, resulting in a poor match between the charger and the battery, which leads to the battery being undercharged or float charging during the charging process, thereby affecting the charging performance of the battery. It is to be seen that it is particularly important to provide a method that may improve the charging compatibility between the charger and the battery for accurate charging of the battery.

### SUMMARY OF THE INVENTION

The technical problems to be solved in the present application is to provide a method and apparatus of intelligent charging control for an automotive battery, which not only improves the charging compatibility between the charger and the battery, but also increases the charging accuracy of the battery, so that occurrence of the battery being undercharged or float charging is decreased, thereby improving the charging performance of the battery to ensure a normal operation of a car.

In order to solve the technical problems mentioned above, disclosed in the first aspect of the present application is a method of intelligent charging control for an automotive battery, the method including:
identifying a battery parameter of the automotive battery to be charged, the battery parameter of the automotive battery including at least one of a rated electrical parameter, a battery type parameter, a charging environment parameter and a battery loss condition; identifying a charging mode corresponding to the automotive battery based on the battery parameter of the automotive battery, in which the charging mode corresponding to the automotive battery is one of a first charging mode, a second charging mode, a cold environment charging mode, a lithium battery charging mode and a repair charging mode; additionally, the first charging mode, the second charging mode and the cold environment charging mode all belong to a target charging mode corresponding to the automotive battery; identifying a present electrical parameter of the automotive battery, and identifying a charging phase of the charging mode corresponding to the automotive battery based on the present electrical parameter of the automotive battery; and identifying a target charging control parameter of the charging phase corresponding to the automotive battery based on the charging phase of the charging mode corresponding to the automotive battery, and performing a charging control operation on the automotive battery based on the target charging control parameter.

As an optional embodiment, in the first aspect of the present invention, steps of identifying a target charging control parameter of the charging phase corresponding to the automotive battery based on the charging phase of the charging mode corresponding to the automotive battery, and performing the charging control operation on the automotive battery based on the target charging control parameter, includes:
identifying a first charging control parameter of a desulphation charging phase corresponding to the automotive battery when the charging mode is identified as one of the target charging modes and the charging phase of the target charging mode is identified as a desulphation charging phase, and performing a first pulse charging control operation on the automotive battery based on the first charging control parameter; determining whether a present charging voltage of the automotive battery is greater than or equal to a preset first voltage parameter threshold during a process of performing the first pulse charging control operation on the automotive battery; when a corresponding determination result is positive, converting the charging phase of the target charging mode from the desulphation charging phase to a pre-charge charging phase, in which the first charging control parameter includes a first duty ratio parameter, a first pulse cycle parameter and a first pulse electrical parameter; and identifying a second charging control parameter of the pre-charge charging phase corresponding to the automotive battery when the charging mode is identified as one of the target charging modes and the charging phase of the target charging mode is identified as the pre-charge charging phase, and performing a first constant-current charging control operation on the automotive battery based on the second charging control parameter; determining whether the present charging voltage of the automotive battery is greater than or equal to a preset second voltage parameter threshold during a process of performing the first constant-current charging control operation on the automotive battery; when a corresponding determination result is positive, converting the charging phase of the target charging mode from the pre-charge charging phase to a first soft start charging phase, in which the second charging control parameter includes a first constant-current electrical parameter.

As an optional embodiment, in the first aspect of the present invention, the method also includes:
identifying a third charging control parameter of the first soft start charging phase corresponding to the automotive battery when the charging mode is identified as one of the target charging modes and the charging phase of the target charging mode is identified as the first soft start charging phase, and performing a first stepped charging control operation on the automotive battery based on the third charging control parameter; determining whether the present charging voltage of the automotive battery is greater than or equal to a preset third voltage parameter threshold during a process of performing the first stepped charging control operation on the automotive battery; when a corresponding determination result is positive, converting the charging phase of the target charging mode from the first soft start charging phase to a first constant-current charging phase, in which the third charging control parameter includes a first stepped electrical parameter and a first stepped charging time parameter; identifying a fourth charging control parameter of the first constant-current charging phase corresponding to the automotive battery when the charging mode is identified as one of the target charging modes and the charging phase of the charging mode is the first constant-current charging phase, and performing a second constant-current charging control operation on the automotive battery based on the fourth charging control parameter; determining whether the present charging voltage of the automotive battery is greater than or equal to a preset fourth voltage parameter threshold during a process of performing the second constant-current charging control operation on the automotive battery; when a corresponding determination result is positive, converting the charging phase of the target charging mode from the first constant-current charging phase to a first optimization charging phase, in which the fourth charging control parameter includes a second constant-current electrical parameter; and identifying a fifth charging control parameter of the first optimization charging phase corresponding to the automotive battery when the charging mode is identified as one of the target charging modes and the charging phase of the charging mode is the first optimization charging phase, and performing a first optimization charging control operation on the automotive battery based on the fifth charging control parameter; determining whether a present first charging parameter of the automotive battery satisfies a preset trickle-charging converting condition during a process of performing the first optimization charging control operation on the automotive battery; when a corresponding determination result is positive, converting the charging phase of the target charging mode from the first optimization charging phase to a trickle charging phase, in which the fifth charging control parameter includes at least one of a first current declining parameter, a second stepped electrical parameter and a second stepped charging time parameter.

As an optional embodiment, in the first aspect of the present invention, the method also includes:
identifying a sixth charging control parameter of the trickle charging phase corresponding to the automotive battery when the charging mode is identified as one of the target charging modes and the charging phase of the charging mode is the trickle charging phasc, and performing a trickle charging control operation on the automotive battery based on the sixth charging control parameter; determining whether the present charging voltage of the automotive battery is greater than or equal to a preset fifth voltage parameter threshold during a process of performing the trickle charging control operation on the automotive battery; when a corresponding determination result is positive, converting the charging phase of the target charging mode from the trickle charging phase to an analysis charging phase, in which the sixth charging control parameter includes a third constant-current electrical parameter; performing a suspend charging control operation on the automotive battery when the charging mode is identified as one of the target charging modes and the charging phase of the charging mode is the analysis charging phase; determining whether the present charging voltage of the automotive battery is smaller than or equal to a preset sixth voltage parameter threshold during a process of performing the suspend charging control operation on the automotive battery; when a corresponding determination result is positive, converting the charging phase of the target charging mode from the analysis charging phase to a maintain charging phase; identifying a seventh charging control parameter of the maintain charging phase corresponding to the automotive battery when the charging mode is identified as one of the target charging modes and the charging phase of the charging mode is the maintain charging phase, and performing a maintain charging control operation on the automotive battery based on the seventh charging control parameter; determining whether the present charging voltage of the automotive battery is greater than or equal to a preset seventh voltage parameter threshold during a process of performing the maintain charging control operation on the automotive battery; when a corresponding determination result is positive, detecting whether the automotive battery is in a access charging status, and if yes, converting the charging phase of the target charging mode from the maintain charging phase to the analysis charging phase, in which the seventh charging control parameter includes a fourth constant-current electrical parameter.

As an optional embodiment, in the first aspect of the present invention, steps of identifying a target charging control parameter of the charging phase corresponding to the automotive battery based on the charging phase of the charging mode corresponding to the automotive battery, and performing the charging control operation on the automotive battery based on the target charging control parameter, includes:
identifying a first lithium battery charging control parameter of a second constant-current charging phase corresponding to the automotive battery when the charging mode is identified as the lithium battery charging mode and the charging phase of the lithium battery charging mode is the second constant-current charging phase, and performing a third constant-current charging control operation on the automotive battery based on the first lithium battery charging control parameter; determining whether a present charging voltage of the automotive battery is greater than or equal to a preset first lithium-battery-voltage-parameter threshold during a process of performing the third constant-current charging control operation on the automotive battery; when a corresponding determination result is positive, converting the charging phase of the lithium battery charging mode from the second constant-current charging phase to a second soft start charging phase, in which the first lithium battery charging control parameter includes a fifth constant-current electrical parameter; and identifying a second lithium battery charging control parameter of the second soft start charging phase corresponding to the automotive battery when the charging mode is identified as the lithium battery charging mode and the charging phase of the lithium battery charging mode is the second soft start charging phase, and performing a second stepped charging control operation on the automotive battery based on the second lithium battery charging control parameter; determining whether the present charging voltage of the automotive battery is greater than or equal to a preset second lithium-battery-voltage-parameter threshold during a process of performing the second stepped charging control operation on the automotive battery; when a corresponding determination result is positive, converting the charging phase of the lithium battery charging mode from the second soft start charging phase to a third constant-current charging phase, in which the second lithium battery charging control parameter includes a third stepped electrical parameter and a third stepped charging time parameter.

As an optional embodiment, in the first aspect of the present invention, the method also includes:
identifying a third lithium battery charging control parameter of the third constant-current charging phase corresponding to the automotive battery when the charging mode is identified as the lithium battery charging mode and the charging phase of the lithium battery charging mode is the third constant-current charging phase, and performing a fourth constant-current charging control operation on the automotive battery based on the third lithium battery charging control parameter; determining whether the present charging voltage of the automotive battery is greater than or equal to a preset third lithium-battery-voltage-parameter threshold during a process of performing the fourth constant-current charging control operation on the automotive battery; when a corresponding determination result is positive, converting the charging phase of the lithium battery charging mode from the third constant-current charging phase to a second optimization charging phase, in which the third lithium battery charging control parameter includes a sixth constant-current electrical parameter; and identifying a fourth lithium battery charging control parameter of the second optimization charging phase corresponding to the automotive battery when the charging mode is identified as the lithium battery charging mode and the charging phase of the lithium battery charging mode is the second optimization charging phase, and performing a second optimization charging control operation on the automotive battery based on the fourth lithium battery charging control parameter; determining whether a present second charging parameter of the automotive battery satisfies a preset stop-charging condition during a process of performing the second optimization charging control operation on the automotive battery; when a corresponding determination result is positive, performing a stop-charging control operation on the automotive battery, in which the fourth lithium battery charging control parameter includes at least one of a second current declining parameter, a fourth stepped electrical parameter and a fourth stepped charging time parameter.

As an optional embodiment, in the first aspect of the present invention, steps of identifying a target charging control parameter of the charging phase corresponding to the automotive battery based on the charging phase of the charging mode corresponding to the automotive battery, and performing the charging control operation on the automotive battery based on the target charging control parameter, includes:
identifying a first repair charging control parameter of a fourth constant-current charging phase corresponding to the automotive battery when the charging mode is identified as the repair charging mode and the charging phase of the repair charging mode is the fourth constant-current charging phase, and performing a fifth constant-current charging control operation on the automotive battery based on the first repair charging control parameter; determining whether a present charging voltage of the automotive battery is greater than or equal to a preset first repair voltage parameter threshold during a process of performing the fifth constant-current charging control operation on the automotive battery; when a corresponding determination result is positive, converting the charging phase of the repair charging mode from the fourth constant-current charging phase to a third optimization charging phase, in which the first repair charging control parameter includes a seventh constant-current electrical parameter; and identifying a second repair charging control parameter of the third optimization charging phase corresponding to the automotive battery when the charging mode is identified as the repair charging mode and the charging phase of the repair charging mode is the third optimization charging phase, and performing a second pulse charging control operation on the automotive battery based on the second repair charging control parameter; determining whether a present charging voltage of the automotive battery is greater than or equal to a preset second repair voltage parameter threshold during a process of performing the second pulse charging control operation on the automotive battery; when a corresponding determination result is positive, performing a stop-charging control operation on the automotive battery, in which the second repair charging control parameter includes a second duty ratio parameter, a second pulse cycle parameter and a second pulse electrical parameter.

Disclosed in the second aspect of the present application is an apparatus of intelligent charging control for automotive battery, the method including:
an identifying module, used for identifying a battery parameter of the automotive battery to be charged, the battery parameter of the automotive battery including at least one of a rated electrical parameter, a battery type parameter, a charging environment parameter and a battery loss condition; identifying a charging mode corresponding to the automotive battery based on the battery parameter of the automotive battery, in which the charging mode corresponding to the automotive battery is one of a first charging mode, a second charging mode, a cold environment charging mode, a lithium battery charging mode and a repair charging mode; additionally, the first charging mode, the second charging mode and the cold environment charging mode all belong to a target charging mode corresponding to the automotive battery; identifying a present electrical parameter of the automotive battery, and identifying a charging phase of the charging mode corresponding to the automotive battery based on the present electrical parameter of the automotive battery; and
a charging control module, used for identifying a target charging control parameter of the charging phase corresponding to the automotive battery based on the charging phase of the charging mode corresponding to the automotive battery, and performing a charging control operation on the automotive battery based on the target charging control parameter.

As an optional embodiment, in the second aspect of the present application, steps of the charging control module identifying a target charging control parameter of the charging phase corresponding to the automotive battery based on the charging phase of the charging mode corresponding to the automotive battery, and performing the charging control operation on the automotive battery based on the target charging control parameter, specifically also includes:
identifying a first charging control parameter of a desulphation charging phase corresponding to the automotive battery when the charging mode is identified as one of the target charging modes and the charging phase of the target charging mode is identified as a desulphation charging phase, and performing a first pulse charging control operation on the automotive battery based on the first charging control parameter; determining whether a present charging voltage of the automotive battery is greater than or equal to a preset first voltage parameter threshold during a process of performing the first pulse charging control operation on the automotive battery; when a corresponding determination result is positive, converting the charging phase of the target charging mode from the desulphation charging phase to a pre-charge charging phase, in which the first charging control parameter includes a first duty ratio parameter, a first pulse cycle parameter and a first pulse electrical parameter; and identifying a second charging control parameter of the pre-charge charging phase corresponding to the automotive battery when the charging mode is identified as one of the target charging modes and the charging phase of the target charging mode is identified as the pre-charge charging phase, and performing a first constant-current charging control operation on the automotive battery based on the second charging control parameter; determining whether the present charging voltage of the automotive battery is greater than or equal to a preset second voltage parameter threshold during a process of performing the first constant-current charging control operation on the automotive battery; when a corresponding determination result is positive, converting the charging phase of the target charging mode from the pre-charge charging phase to a first soft start charging phase, in which the second charging control parameter includes a first constant-current electrical parameter.

As an optional embodiment, in the second aspect of the present application, steps of the charging control module identifying a target charging control parameter of the charging phase corresponding to the automotive battery based on the charging phase of the charging mode corresponding to the automotive battery, and performing the charging control operation on the automotive battery based on the target charging control parameter, specifically also includes:
identifying a third charging control parameter of the first soft start charging phase corresponding to the automotive battery when the charging mode is identified as one of the target charging modes and the charging phase of the target charging mode is identified as the first soft start charging phase, and performing a first stepped charging control operation on the automotive battery based on the third charging control parameter; determining whether the present charging voltage of the automotive battery is greater than or equal to a preset third voltage parameter threshold during a process of performing the first stepped charging control operation on the automotive battery; when a corresponding determination result is positive, converting the charging phase of the target charging mode from the first soft start charging phase to a first constant-current charging phase, in which the third charging control parameter includes a first stepped electrical parameter and a first stepped charging time parameter; identifying a fourth charging control parameter of the first constant-current charging phase corresponding to the automotive battery when the charging mode is identified as one of the target charging modes and the charging phase of the charging mode is the first constant-current charging phase, and performing a second constant-current charging control operation on the automotive battery based on the fourth charging control parameter; determining whether the present charging voltage of the automotive battery is greater than or equal to a preset fourth voltage parameter threshold during a process of performing the second constant-current charging control operation on the automotive battery; when a corresponding determination result is positive, converting the charging phase of the target charging mode from the first constant-current charging phase to a first optimization charging phase, in which the fourth charging control parameter includes a second constant-current electrical parameter; and identifying a fifth charging control parameter of the first optimization charging phase corresponding to the automotive battery when the charging mode is identified as one of the target charging modes and the charging phase of the charging mode is the first optimization charging phase, and performing a first optimization charging control operation on the automotive battery based on the fifth charging control parameter; determining whether a present first charging parameter of the automotive battery satisfies a preset trickle-charging converting condition during a process of performing the first optimization charging control operation on the automotive battery; when a corresponding determination result is positive, converting the charging phase of the target charging mode from the first optimization charging phase to a trickle charging phase, in which the fifth charging control parameter includes at least one of a first current declining parameter, a second stepped electrical parameter and a second stepped charging time parameter.

As an optional embodiment, in the second aspect of the present application, steps of the charging control module identifying a target charging control parameter of the charging phase corresponding to the automotive battery based on the charging phase of the charging mode corresponding to the automotive battery, and performing the charging control operation on the automotive battery based on the target charging control parameter, specifically also includes:
identifying a sixth charging control parameter of the trickle charging phase corresponding to the automotive battery when the charging mode is identified as one of the target charging modes and the charging phase of the charging mode is the trickle charging phase, and performing a trickle charging control operation on the automotive battery based on the sixth charging control parameter; determining whether the present charging voltage of the automotive battery is greater than or equal to a preset fifth voltage parameter threshold during a process of performing the trickle charging control operation on the automotive battery; when a corresponding determination result is positive, converting the charging phase of the target charging mode from the trickle charging phase to an analysis charging phase, in which the sixth charging control parameter includes a third constant-current electrical parameter; performing a suspend charging control operation on the automotive battery when the charging mode is identified as one of the target charging modes and the charging phase of the charging mode is the analysis charging phase; determining whether the present charging voltage of the automotive battery is smaller than or equal to a preset sixth voltage parameter threshold during a process of performing the suspend charging control operation on the automotive battery; when a corresponding determination result is positive, converting the charging phase of the target charging mode from the analysis charging phase to a maintain charging phase; identifying a seventh charging control parameter of the maintain charging phase corresponding to the automotive battery when the charging mode is identified as one of the target charging modes and the charging phase of the charging mode is the maintain charging phase, and performing a maintain charging control operation on the automotive battery based on the seventh charging control parameter; determining whether the present charging voltage of the automotive battery is greater than or equal to a preset seventh voltage parameter threshold during a process of performing the maintain charging control operation on the automotive battery; when a corresponding determination result is positive, detecting whether the automotive battery is in a access charging status, and if yes, converting the charging phase of the target charging mode from the maintain charging phase to the analysis charging phase, in which the seventh charging control parameter includes a fourth constant-current electrical parameter.

As an optional embodiment, in the second aspect of the present application, steps of the charging control module identifying a target charging control parameter of the charging phase corresponding to the automotive battery based on the charging phase of the charging mode corresponding to the automotive battery, and performing the charging control operation on the automotive battery based on the target charging control parameter, specifically includes:
identifying a first lithium battery charging control parameter of a second constant-current charging phase corresponding to the automotive battery when the charging mode is identified as the lithium battery charging mode and the charging phase of the lithium battery charging mode is the second constant-current charging phase, and performing a third constant-current charging control operation on the automotive battery based on the first lithium battery charging control parameter; determining whether a present charging voltage of the automotive battery is greater than or equal to a preset first lithium-battery-voltage-parameter threshold during a process of performing the third constant-current charging control operation on the automotive battery; when a corresponding determination result is positive, converting the charging phase of the lithium battery charging mode from the second constant-current charging phase to a second soft start charging phase, in which the first lithium battery charging control parameter includes a fifth constant-current electrical parameter; and identifying a second lithium battery charging control parameter of the second soft start charging phase corresponding to the automotive battery when the charging mode is identified as the lithium battery charging mode and the charging phase of the lithium battery charging mode is the second soft start charging phase, and performing a second stepped charging control operation on the automotive battery based on the second lithium battery charging control parameter; determining whether the present charging voltage of the automotive battery is greater than or equal to a preset second lithium-battery-voltage-parameter threshold during a process of performing the second stepped charging control operation on the automotive battery; when a corresponding determination result is positive, converting the charging phase of the lithium battery charging mode from the second soft start charging phase to a third constant-current charging phase, in which the second lithium battery charging control parameter includes a third stepped electrical parameter and a third stepped charging time parameter.

As an optional embodiment, in the second aspect of the present application, steps of the charging control module identifying a target charging control parameter of the charging phase corresponding to the automotive battery based on the charging phase of the charging mode corresponding to the automotive battery, and performing the charging control operation on the automotive battery based on the target charging control parameter, specifically also includes:
identifying a third lithium battery charging control parameter of the third constant-current charging phase corresponding to the automotive battery when the charging mode is identified as the lithium battery charging mode and the charging phase of the lithium battery charging mode is the third constant-current charging phase, and performing a fourth constant-current charging control operation on the automotive battery based on the third lithium battery charging control parameter; determining whether the present charging voltage of the automotive battery is greater than or equal to a preset third lithium-battery-voltage-parameter threshold during a process of performing the fourth constant-current charging control operation on the automotive battery; when a corresponding determination result is positive, converting the charging phase of the lithium battery charging mode from the third constant-current charging phase to a second optimization charging phase, in which the third lithium battery charging control parameter includes a sixth constant-current electrical parameter; and identifying a fourth lithium battery charging control parameter of the second optimization charging phase corresponding to the automotive battery when the charging mode is identified as the lithium battery charging mode and the charging phase of the lithium battery charging mode is the second optimization charging phase, and performing a second optimization charging control operation on the automotive battery based on the fourth lithium battery charging control parameter; determining whether a present second charging parameter of the automotive battery satisfies a preset stop-charging condition during a process of performing the second optimization charging control operation on the automotive battery; when a corresponding determination result is positive, performing a stop-charging control operation on the automotive battery, in which the fourth lithium battery charging control parameter includes at least one of a second current declining parameter, a fourth stepped electrical parameter and a fourth stepped charging time parameter.

As an optional embodiment, in the second aspect of the present application, steps of the charging control module identifying a target charging control parameter of the charging phase corresponding to the automotive battery based on the charging phase of the charging mode corresponding to the automotive battery, and performing a charging control operation on the automotive battery based on the target charging control parameter, specifically includes: identifying a first repair charging control parameter of a fourth constant-current charging phase corresponding to the automotive battery when the charging mode is identified as the repair charging mode and the charging phase of the repair charging mode is the fourth constant-current charging phase, and performing a fifth constant-current charging control operation on the automotive battery based on the first repair charging control parameter; determining whether a present charging voltage of the automotive battery is greater than or equal to a preset first repair voltage parameter threshold during a process of performing the fifth constant-current charging control operation on the automotive battery; when a corresponding determination result is positive, converting the charging phase of the repair charging mode from the fourth constant-current charging phase to a third optimization charging phase, in which the first repair charging control parameter includes a seventh constant-current electrical parameter; and identifying a second repair charging control parameter of the third optimization charging phase corresponding to the automotive battery when the charging mode is identified as the repair charging mode and the charging phase of the repair charging mode is the third optimization charging phase, and performing a second pulse charging control operation on the automotive battery based on the second repair charging control parameter; determining whether a present charging voltage of the automotive battery is greater than or equal to a preset second repair voltage parameter threshold during a process of performing the second pulse charging control operation on the automotive battery; when a corresponding determination result is positive, performing a stop-charging control operation on the automotive battery, in which the second repair charging control parameter includes a second duty ratio parameter, a second pulse cycle parameter and a second pulse electrical parameter.

Disclosed as a third aspect in the present application is an apparatus of intelligent charging control for an automotive battery, the apparatus including:
a memory, memorized with an executable code, and
a processor, coupled with the memory,
in which the processor invokes the executable code memorized in the memory to perform the method of intelligent charging control for an automotive battery disclosed in the first aspect of the present application.

Disclosed as a fourth aspect in the present application is a non-transitory computer memory medium, and the non-transitory computer memory medium memorizes computer instructions; when the computer instructions are invoked, the method of intelligent charging control for an automotive battery disclosed as the first aspect of the present application is performed.

Compared to the prior art, the embodiments of the present application have beneficial effects as follows.

In the embodiments of the present application, identifying a battery parameter of the automotive battery to be charged; identifying a charging mode corresponding to the automotive battery based on the battery parameter; identifying a present electrical parameter of the automotive battery, and identifying the charging phase of the charging mode corresponding to the automotive battery based on the present electrical parameter; and identifying a target charging control parameter of the charging phase corresponding to the automotive battery based on the charging phase of the charging mode corresponding to the automotive battery, and performing a charging control operation on the automotive battery based on the target charging control parameter. It is to be seen that implementation of the present application enables intelligent charging of an automotive battery through multiple charging modes and multiple charging phases. In such a setup, by improving the charging compatibility between the charger and the battery, it may not only improve the charging matching between the charger and the battery, but also may improve the charging accuracy of the battery, so that the occurrence of the battery being undercharged or float charging is decreased, thereby improving the charging performance of the battery to ensure a normal operation of a car.

### BRIEF DESCRIPTION OF THE DRAWINGS

In order to illustrate the technical solutions of the embodiments of the present application more clearly, the following drawings are briefly described as required in the context of the embodiments. Obviously, the following drawings only illustrate only some of the embodiments of the present application. Other relevant drawings may be obtained on the basis of these drawings without any creative effort by those skilled in the art.

FIG. 1 is a flow diagram of automotive battery charging control of the target charging mode disclosed in the embodiments of the present application.

FIG. 2 is a flow diagram of automotive battery charging control of the lithium battery charging mode disclosed in the embodiments of the present application.

FIG. 3 is a flow diagram of automotive battery charging control of the repair charging mode disclosed in the embodiments of the present application.

FIG. 4 is a flow diagram of a method of intelligent charging control for an automotive battery disclosed in the embodiments of the present application.

FIG. 5 is a flow diagram of another method of intelligent charging control for an automotive battery disclosed in the embodiments of the present application.

FIG. 6 is a structural diagram of an apparatus of intelligent charging control for an automotive battery disclosed in the embodiments of the present application.

FIG. 7 is a structural diagram of another apparatus of intelligent charging control for an automotive battery disclosed in the embodiments of the present application.

### DETAILED DESCRIPTION OF THE PREFERRED EMBODIMENTS

For better understanding of the present application solutions by those skilled in the art, the technical solutions in the embodiments of the present application are clearly and completely described and discussed below in conjunction with the attached drawings of the embodiments in the present application. Obviously, the embodiments described herein are only some of the embodiments of the present application but not all of them. Based on the embodiments in the present application, all other embodiments acquired by those skilled in the art without inventive effort fall within the scope of protection of the present application.

The terms “first”, “second”, and the like in the specification, the claims and the above-mentioned drawings of the present application are used to identify different objects and are not intended to describe a particular sequence. In addition, the terms “comprise” and “include”, and any derivatives and conjugations thereof, are intended to cover non-exclusive inclusion. For example, a process, method, apparatus, product, or device that comprises a series of steps or units is not limited to the listed steps or units, but optionally also comprises steps or units that are not listed, or optionally also comprises other steps or units that are inherent to those processes, methods, products, or devices.

The term “embodiment” herein means that a particular feature, structure or characteristic described in conjunction with an embodiment may be comprised in at least one embodiment of the present application. The presence of the term in various places in the specification does not necessarily indicate the same embodiment, nor is it a separate or alternative embodiment that is mutually exclusive with other embodiments. It is understood, both explicitly and implicitly, by those skilled in the art that the embodiments described herein may be combined with other embodiments.

Disclosed in the present application is a method and apparatus of intelligent charging control for an automotive battery, which not only improves the charging compatibility between the charger and the battery, but also increases the charging accuracy of the battery, so that occurrence of the battery being undercharged or float charging is decreased, thereby improving the charging performance of the battery to ensure a normal operation of a car. Detailed descriptions are provided as follows.

### Embodiment 1

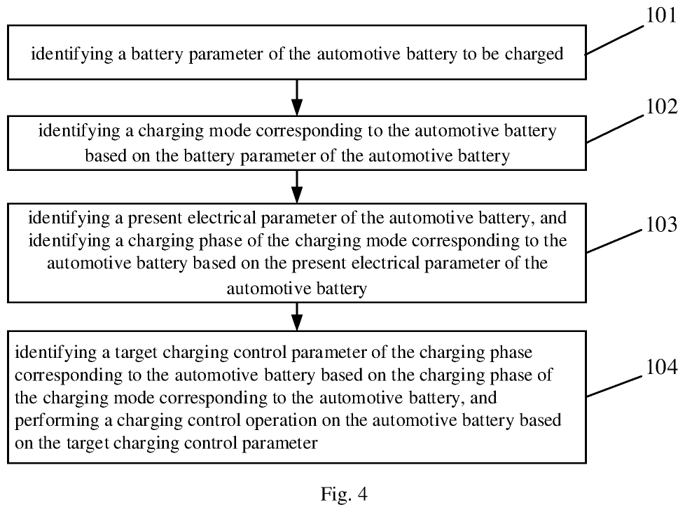

Referring to FIG. 4, FIG. 4 is a flow diagram of a method of intelligent charging control for an automotive battery disclosed in the embodiments of the present application. The method of intelligent charging control for an automotive battery described in FIG. 4 may be applied to an automotive battery of various types for charging. Optionally, an automotive battery may include such as nickel-chromium batteries, nickel-hydrogen batteries, lithium-ion batteries and lithium polymer batteries, which is not limited in the present embodiment of the application. Optionally, the method may be achieved by a battery charging control system, in which the battery charging control system may be integrated in an intelligent charging apparatus (such as a charger), or it may be separate from the intelligent charging apparatus, or it may also be a local server or a cloud server used for processing the battery charging control process, which is not limited in the present embodiment of the application. As shown in FIG. 4, the method of intelligent charging control for an automotive battery may include steps as follows.

At step 101, identifying a battery parameter of the automotive battery to be charged.

In the present embodiment of the application, optionally, the battery parameter of the automotive battery includes at least one of a rated electrical parameter, a battery type parameter, a charging environment parameter and a battery loss condition. Further and optionally, the rated electrical parameter includes at least one of a rated battery volume parameter, a rated charging voltage parameter and a rated charging current parameter. The charging environment parameter includes an environment humidity parameter and/or an environment temperature parameter. The battery loss condition includes a battery volume loss condition.

At step 102, identifying a charging mode corresponding to the automotive battery based on the battery parameter of the automotive battery.

In the present embodiment of the application, optionally, the charging mode corresponding to the automotive battery is one of a first charging mode, a second charging mode, a cold environment charging mode, a lithium battery charging mode and a repair charging mode. Specifically, the first charging mode, the second charging mode and the cold environment charging mode all belong to the target charging mode corresponding to the automotive battery, in which the corresponding charging mode of the automotive battery is identified to be the second charging mode when the rated battery volume parameter of the automotive battery is smaller than or equal to a preset volume parameter threshold, and the charging mode corresponding to the automotive battery is identified to be the cold environment charging mode when the environment temperature parameter is smaller than or equal to a preset temperature parameter threshold.

At step 103, identifying a present electrical parameter of the automotive battery, and identifying a charging phase of the charging mode corresponding to the automotive battery based on the present electrical parameter of the automotive battery.

In the present embodiment of the application, each charging mode includes multiple charging phases, and the charging phase is specifically identified based on the present electrical parameter of the automotive battery. When the present charging phase of the automotive battery is completed, it may be converted to a next charging phase automatically, or a notice information may be output so that user may adjust the charging phase. Until the last charging phase of the charging mode is completed, ending the charging control operation of the battery. Optionally, the present electrical parameter of the automotive battery may be the present voltage parameter.

At step 104, identifying a target charging control parameter of the charging phase corresponding to the automotive battery based on the charging phase of the charging mode corresponding to the automotive battery, and performing a charging control operation on the automotive battery based on the target charging control parameter.

In the present embodiment of the application, each charging phase of each charging mode corresponds to a target charging control parameter, such as relatedly a charging current parameter, a charging voltage parameter and a charging time parameter. Optionally, the present charging electrical parameters of the automotive battery may be displayed by a screen, such as currently the charging mode, the charging phase, the charging voltage and the charging current.

It is to be noted that the hardware circuit of the charging device may work as follows. The charging device, when connected to AC power, outputs a DC voltage to the transformer through a primary rectifier-filter circuit. Then the voltage steps down to two secondary outputs by transformer-coupling, and the secondary outputs feed the op-amp voltage loop to the optocoupler through the op-amp. The primary pulse width modulation IC chip receives feedback through the optocoupler. Finally, the duty ratio of the switching tube is controlled through the pulse width modulation IC chip to ensure the stability of the output voltage.

For example, after the charging device is powered up, the battery voltage may be detected through the voltage detecting circuit first, and then the MCU adjusts different pulse width modulation signals to the current loop of the op-amp. After that, the current signal detected by the op-amp is converted to a voltage signal, and the voltage signal is output to the I/O interface of the MCU. Finally, the duty ratio of the op-amp current loop is adjusted by the MCU, and then it is fed to the primary pulse width modulation IC chip to output constant current for charging battery. Similarly, different pulse width modulation signals may be adjusted by the MCU, and they are provided to the voltage loop of the op-amp. The primary pulse width modulation IC chip receives feedback through the optocoupler so as to stably output voltage for charging battery.

It is to be seen that implementation of the present application enables intelligent charging of an automotive battery through multiple charging modes and multiple charging phases. In such a setup, by improving the charging compatibility between the charger and the battery, it may not only improve the charging matching between the charger and the battery, but also may improve the charging accuracy of the battery, so that the occurrence of the battery being undercharged or float charging is decreased, thereby improving the charging performance of the battery to ensure a normal operation of a car.

In an optional embodiment, the step 104 mentioned above of identifying a target charging control parameter of the charging phase corresponding to the automotive battery based on the charging phase of the charging mode corresponding to the automotive battery, and performing the charging control operation on the automotive battery based on the target charging control parameter, includes:
identifying a first charging control parameter of a desulphation charging phase corresponding to the automotive battery when the charging mode is identified as one of the target charging modes and the charging phase of the target charging mode is identified as a desulphation charging phase, and performing a first pulse charging control operation on the automotive battery based on the first charging control parameter; determining whether a present charging voltage of the automotive battery is greater than or equal to a preset first voltage parameter threshold during a process of performing a first pulse charging control operation on the automotive battery; when a corresponding determination result is positive, converting the charging phase of the target charging mode from the desulphation charging phase to a pre-charge charging phase; and
identifying a second charging control parameter of the pre-charge charging phase corresponding to the automotive battery when the charging mode is identified as one of the target charging modes and the charging phase of the target charging mode is identified as the pre-charge charging phase, and performing a first constant-current charging control operation on the automotive battery based on the second charging control parameter; determining whether the present charging voltage of the automotive battery is greater than or equal to a preset second voltage parameter threshold during a process of performing a first constant-current charging control operation on the automotive battery; when a corresponding determination result is positive, converting the charging phase of the target charging mode from the pre-charge charging phase to a first soft start charging phase.

In the present optional embodiment, the target charging modes, i.e., the first charging mode, the second charging mode and the cold environment charging mode, all include, besides an access diagnosis phase, a desulphation charging phase, a pre-charge charging phase, a first soft start charging phase, a first constant-current charging phase, a first optimization charging phase, a trickle charging phase, an analysis charging phase and a maintain charging phase. Optionally, the first charging control parameter includes a first duty ratio parameter, a first pulse cycle parameter and a first pulse electrical parameter, and the second charging control parameter includes a first constant-current electrical parameter.

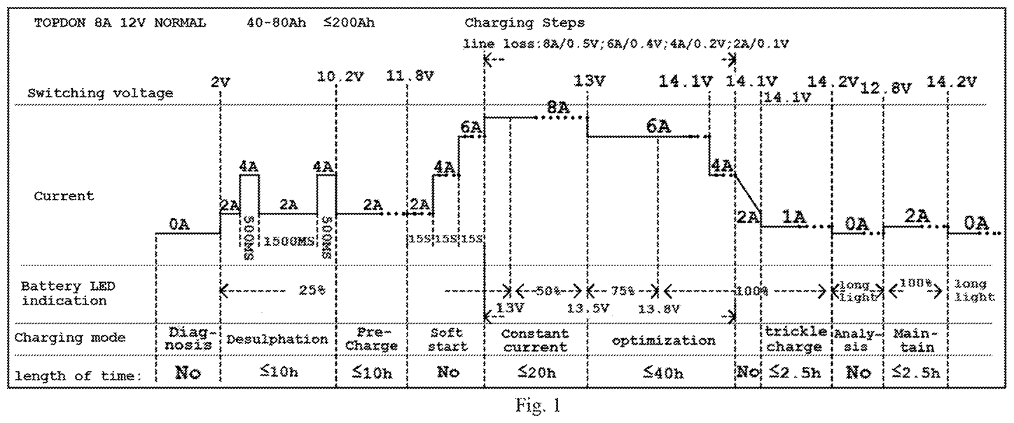

For example, as shown in FIG. 1, FIG. 1 is a flow diagram of automotive battery charging control of the target charging mode disclosed in the embodiments of the present application. Specifically, in FIG. 1, the normal mode indicates the first charging mode (normal charging mode), the desulphation indicates the desulphation charging phase, and the pre-charge indicates the pre-charge charging phase. As shown in FIG. 1, of a battery with a rated voltage of 12V and a rated current of 8 A, when the present voltage parameter of the battery falls within a range of 2V-10.2V, it is identified that the charging phase of the first charging mode of the battery is the desulphation charging phase; when the present voltage parameter of the battery falls with a range of 10.2V-11.8V, it is identified that the charging phase of the first charging mode of the battery is the pre-charge charging phase. In addition, in the desulphation charging phase, a first duty ratio parameter may be 25%, the first pulse cycle parameter may be 2000 ms, and the first pulse electrical parameter may be 2 A or 4 A, so as to achieve that the chemicals inside the battery are activated. The first constant-current electrical parameter of the pre-charge charging phase may be 2 A. Additionally, of a battery with a rated voltage of 24V and a rated current of 8 A, the current voltage parameter range to be referenced may be proportional to the voltage parameter range mentioned above. That is to say, when the present voltage parameter of the battery falls within a range of 4V-20.4V, it is identified that the charging phase of the first charging mode of the battery is the desulphation charging phase; when the present voltage parameter of the battery falls with a range of 20.4V-23.6V, it is identified that the charging phase of the first charging mode of the battery is the pre-charge charging phase, of a battery with a rated voltage of 12V and a rated current of 4 A, the related charging electrical parameter to be required may also be proportional to the charging electrical parameter mentioned above, i.e., when the battery is in the desulphation charging phase, the first pulse electrical parameter thereof may be 1 A or 2 A.

It is to be seen that, by adopting the present optional embodiment, the related charging control parameter may be identified of the desulphation charging phase and the pre-charge charging phase of the automotive battery so as to implement the charging control operation on the automotive battery. In such a setup, it may improve the reliability and accuracy of the charging control in the desulphation charging phase and the pre-charge charging phase of the automotive battery, so that the occurrence of the battery being undercharged or float charging is decreased through the battery activation, thereby improving the charging performance of the battery. Meanwhile, the related charging electrical parameter of each charging phase may be adjusted of different rated electrical parameters of the battery, which facilitates to improve the charging compatibility between the charging device and the battery, so that it facilitates to improve the charging matching between the charging device and the battery, thereby facilitating to improve an overall charging performance of the charging device for the battery.

In an optional embodiment, the method also includes:
identifying a third charging control parameter of the first soft start charging phase corresponding to the automotive battery when the charging mode is identified as one of the target charging modes and the charging phase of the target charging mode is identified as the first soft start charging phase, and performing a first stepped charging control operation on the automotive battery based on the third charging control parameter; determining whether the present charging voltage of the automotive battery is greater than or equal to a preset third voltage parameter threshold during a process of performing a first stepped charging control operation on the automotive battery; when a corresponding determination result is positive, converting the charging phase of the target charging mode from the first soft start charging phase to a first constant-current charging phase;
identifying a fourth charging control parameter of the first constant-current charging phase corresponding to the automotive battery when the charging mode is identified as one of the target charging modes and the charging phase of the charging mode is the first constant-current charging phase, and performing a second constant-current charging control operation on the automotive battery based on the fourth charging control parameter; determining whether the present charging voltage of the automotive battery is greater than or equal to a preset fourth voltage parameter threshold during a process of performing a second constant-current charging control operation on the automotive battery; when a corresponding determination result is positive, converting the charging phase of the target charging mode from the first constant-current charging phase to a first optimization charging phase; and
identifying a fifth charging control parameter of the first optimization charging phase corresponding to the automotive battery when the charging mode is identified as one of the target charging modes and the charging phase of the charging mode is the first optimization charging phase, and performing a first optimization charging control operation on the automotive battery based on the fifth charging control parameter; determining whether a present first charging parameter of the automotive battery satisfies a preset trickle-charging converting condition during a process of performing the first optimization charging control operation on the automotive battery; when a corresponding determination result is positive, converting the charging phase of the target charging mode from the first optimization charging phase to a trickle charging phase.

In the present optional embodiment, as shown in FIG. 1, Soft start indicates the first soft start charging phase; Constant current indicates the first constant-current charging phase; and optimization indicates the first optimization charging phase. Optionally, the third charging control parameter includes a first stepped electrical parameter and a first stepped charging time parameter, the fourth charging control parameter includes a second constant-current electrical parameter, and the fifth charging control parameter includes at least one of a first current declining parameter, a second stepped electrical parameter and a second stepped charging time parameter. Further and optionally, as shown in FIG. 1, the first stepped electrical parameter and the second stepped electrical parameter may all include corresponding electrical parameters of each step in multiple steps. In addition, the first current declined parameter may include a current declined slope, a current declined starting parameter, and a current declined ending parameter. Further and optionally, the first optimization charging control operation is as shown in FIG. 1. The charging is starting with a voltage of 13V and a constant current of 8 A until the voltage reaches 14.1V, and then the constant-current parameter is gradually decreased to 2 A to realize a constant-voltage of 14.1V charging for the battery, so as to achieve a fully charging of the battery. Specifically, determining whether a present first charging parameter of the automotive battery satisfies a preset trickle-charging converting condition, in which the present charging current parameter may be detected whether it is decreased to 2 A as shown in FIG. 1, if yes, it is confirm that the automotive battery satisfies the preset trickle-charging converting condition.

It is to be seen that, by adopting the present optional embodiment, the related charging control parameter may be identified of the first soft start charging phase, the first constant-current charging phase and the first optimization charging phase of the automotive battery to implement the charging control operation on the automotive battery. In such a setup, it improves the reliability and accuracy of charging control operation on the first soft start charging phase, the first constant-current charging phase, and the first optimization charging phase of the automotive battery, so that a fully charging of the battery is achieved to decrease the occurrence of float charging or insufficient charging of batteries, thereby improving the charging performance of the battery to ensure a smooth launching of a car.

In an optional embodiment, the method also includes:
identifying a sixth charging control parameter of the trickle charging phase corresponding to the automotive battery when the charging mode is identified as one of the target charging modes and the charging phase of the charging mode is the trickle charging phase, and performing a trickle charging control operation on the automotive battery based on the sixth charging control parameter; determining whether the present charging voltage of the automotive battery is greater than or equal to a preset fifth voltage parameter threshold during a process of performing the trickle charging control operation on the automotive battery; when a corresponding determination result is positive, converting the charging phase of the target charging mode from the trickle charging phase to an analysis charging phase;
performing a suspend charging control operation on the automotive battery when the charging mode is identified as one of the target charging modes and the charging phase of the charging mode is the analysis charging phase; determining whether the present charging voltage of the automotive battery is smaller than or equal to a preset sixth voltage parameter threshold during a process of performing the suspend charging control operation on the automotive battery; when a corresponding determination result is positive, converting the charging phase of the target charging mode from the analysis charging phase to a maintain charging phase;
identifying a seventh charging control parameter of the maintain charging phase corresponding to the automotive battery when the charging mode is identified as one of the target charging modes and the charging phase of the charging mode is the maintain charging phase, and performing a maintain charging control operation on the automotive battery based on the seventh charging control parameter; determining whether the present charging voltage of the automotive battery is greater than or equal to a preset seventh voltage parameter threshold during a process of performing the maintain charging control operation on the automotive battery; when a corresponding determination result is positive, detecting whether the automotive battery is in a access charging status, and if yes, converting the charging phase of the target charging mode from the maintain charging phase to the analysis charging phase.

In the present optional embodiment, as shown in FIG. 1, trickle charge indicates the trickle charging phase; analysis indicates the analysis charging phase; and maintain indicates the maintain charging phase. Optionally, the sixth charging control parameter includes a third constant-current electrical parameter, and the seventh charging control parameter includes a fourth constant-current electrical parameter. For example, as shown in FIG. 1, of a battery with a rated current of 8 A and a rated voltage of 12V, when the battery is in the analysis charging phase, charging control operation of the battery is suspended; when the present charging voltage of the battery is decreased to 12.8V, entering the maintain charging phase, and the battery is charging under a constant current of 2 A; when the present charging voltage of the battery is increased to 14.2V, entering the analysis charging phase; so the cycle continues.

It is to be seen that, by adopting the present optional embodiment, the related charging control parameter may be identified of the trickle charging phase, the analysis charging phase and the maintain charging phase of the automotive battery, so as to implement a charging control operation on the automotive battery, which is achieved that the charging phases of automotive battery may be converted intelligently. In such a setup, it may improve the reliability and the accuracy of charging control during the trickle charging phase, the analysis charging phase and the maintain charging phase of the battery, which may effectively decrease the occurrence of float charging or insufficient charging of batteries, so as to improve the charging performance of the battery, thereby improving the user stickiness of the charging device.

In an optional embodiment, the step 104 mentioned above of identifying a target charging control parameter of the charging phase corresponding to the automotive battery based on the charging phase of the charging mode corresponding to the automotive battery, and performing the charging control operation on the automotive battery based on the target charging control parameter, includes:
identifying a first lithium battery charging control parameter of a second constant-current charging phase corresponding to the automotive battery when the charging mode is identified as the lithium battery charging mode and the charging phase of the lithium battery charging mode is the second constant-current charging phase, and performing a third constant-current charging control operation on the automotive battery based on the first lithium battery charging control parameter; determining whether a present charging voltage of the automotive battery is greater than or equal to a preset first lithium-battery-voltage-parameter threshold during a process of performing the third constant-current charging control operation on the automotive battery; when a corresponding determination result is positive, converting the charging phase of the lithium battery charging mode from the second constant-current charging phase to a second soft start charging phase; and
identifying a second lithium battery charging control parameter of the second soft start charging phase corresponding to the automotive battery when the charging mode is identified as the lithium battery charging mode and the charging phase of the lithium battery charging mode is the second soft start charging phase, and performing a second stepped charging control operation on the automotive battery based on the second lithium battery charging control parameter; determining whether the present charging voltage of the automotive battery is greater than or equal to a preset second lithium-battery-voltage-parameter threshold during a process of performing the second stepped charging control operation on the automotive battery; when a corresponding determination result is positive, converting the charging phase of the lithium battery charging mode from the second soft start charging phase to a third constant-current charging phase.

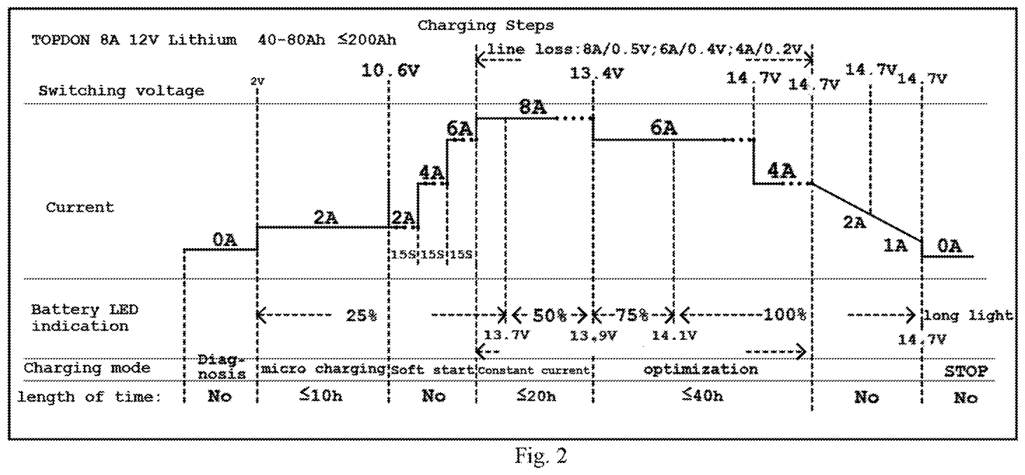

In the present optional embodiment, as shown in FIG. 2, FIG. 2 is a flow chart of the automotive battery charging control of the lithium battery charging mode disclosed in the embodiments of the present application. As shown in FIG. 2, micro charging indicates the second constant-current charging, and soft start indicates the second soft start charging phase. Optionally, referring to FIG. 2, the first lithium battery charging control parameter includes a fifth constant-current electrical parameter, and the second lithium battery charging control parameter includes a third stepped electrical parameter and a third stepped charging time parameter. Further and optionally, the third stepped electrical parameter may include the corresponding electrical parameters of each step in multiple steps, and the third stepped charging time parameter may include the corresponding charging time parameters of each step in multiple steps. Further and optionally, of a lithium battery, similarly, the voltage parameter range corresponding to the present charging phase and the required related charging electrical parameters of the automotive battery may also be determined based on specific rated electrical parameters, the standard voltage parameter range under each charging phase of a standard lithium battery with a rated current of 8 A and a rated voltage of 12V as shown in FIG. 2, and the proportion between the required standard related charging electrical parameters.

It is to be seen that, by adopting the present optional embodiment, the related charging control parameter may be identified of the second constant-current charging phase and the second soft start charging phase of the automotive battery of lithium type, so as to implement a charging control operation on the automotive battery. In such a setup, it may improve the reliability and accuracy of charging control in the second constant-current charging phase and the second soft start charging phase of the automotive battery, so as to decrease the occurrence of float charging or insufficient charging of batteries, thereby improving the charging performance of the battery. Meanwhile, the related charging electrical parameter of each charging phase may be adjusted of different rated electrical parameters of the lithium battery, which facilitates to improve the charging compatibility between the charging device and the lithium battery, so that it facilitates to improve the charging matching between the charging device and the lithium battery, thereby facilitating to improve an overall charging performance of the charging device for the battery.

In an optional embodiment, the method also includes:
identifying a third lithium battery charging control parameter of the third constant-current charging phase corresponding to the automotive battery when the charging mode is identified as the lithium battery charging mode and the charging phase of the lithium battery charging mode is the third constant-current charging phase, and performing a fourth constant-current charging control operation on the automotive battery based on the third lithium battery charging control parameter; determining whether the present charging voltage of the automotive battery is greater than or equal to a preset third lithium-battery-voltage-parameter threshold during a process of performing the fourth constant-current charging control operation on the automotive battery; when a corresponding determination result is positive, converting the charging phase of the lithium battery charging mode from the third constant-current charging phase to a second optimization charging phase, in which the third lithium battery charging control parameter includes a sixth constant-current electrical parameter; and
identifying a fourth lithium battery charging control parameter of the second optimization charging phase corresponding to the automotive battery when the charging mode is identified as the lithium battery charging mode and the charging phase of the lithium battery charging mode is the second optimization charging phase, and performing a second optimization charging control operation on the automotive battery based on the fourth lithium battery charging control parameter; determining whether a present second charging parameter of the automotive battery satisfies a preset stop-charging condition during a process of performing the second optimization charging control operation on the automotive battery; when a corresponding determination result is positive, performing a stop-charging control operation on the automotive battery.

In the present optional embodiment, as shown in FIG. 2, constant current indicates the third constant-current charging phase, and optimization indicates the second optimization charging phase. Optionally, the third lithium battery charging control parameter includes a sixth constant-current electrical parameter, and the fourth lithium battery charging control parameter includes at least one of a second current declining parameter, a fourth stepped electrical parameter and a fourth stepped charging time parameter. Further and optionally, as shown in FIG. 2, the fourth stepped electrical parameter may include electrical parameters of each corresponding step of multiple steps. The fourth stepped charging time parameter may include charging time parameters of each corresponding step of multiple steps. The second current declined parameter may include corresponding current declined slope, current declined starting parameter and current declined ending parameter. Further and optionally, the second optimization charging control operation is as shown in FIG. 2. The charging is starting with a voltage of 13.4V and a constant current of 6 A until the voltage reaches 14.7V, and then the constant-current parameter is gradually decreased to 1 A to realize a constant-voltage of 14.7V charging for the battery, so as to achieve a fully charging of the automotive battery of lithium type. Specifically, the step of determining whether the present second charging parameter of the automotive battery satisfies a preset stop-charging condition may be as shown in FIG. 2. determining whether the present charging current parameter is decreased to 1 A; when yes, then it is confirmed that the automotive battery satisfies the preset stop-charging condition.

It is to be seen that, by implement the present embodiment of the application, the related charging control parameter may be identified of the third constant-current charging phase and the second optimization charging phase of the automotive battery of lithium type, so as to implement a charging control operation on the automotive battery. In such a setup, while improving the compatibility of the charging device for the automotive battery, it may improve the reliability and accuracy of charging control in the third constant-current charging phase and the second optimization charging phase of the automotive battery of lithium type, so that a fully charging of the lithium battery is achieved to decrease the occurrence of float charging or insufficient charging of batteries, thereby improving the charging performance of the lithium battery to ensure a smooth launching of a car.

### Embodiment 2

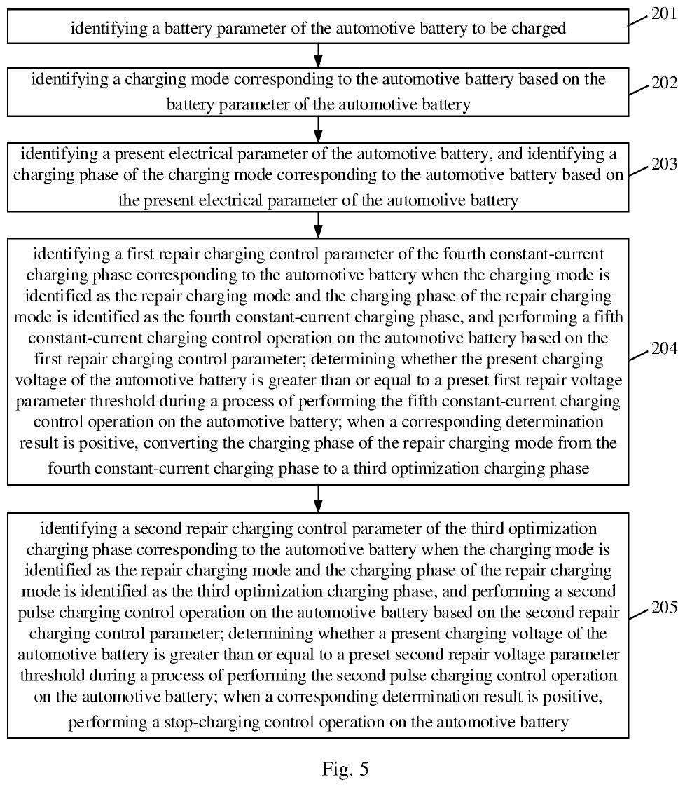

Referring to FIG. 5, FIG. 5 is a flow diagram of a method of intelligent charging control for an automotive battery disclosed in the embodiments of the present application. The method of intelligent charging control for an automotive battery described in FIG. 5 may be applied to automotive batteries of various types for charging. Optionally, automotive batteries may include such as nickel-chromium batteries, nickel-hydrogen batteries, lithium-ion batteries and lithium polymer batteries, which is not limited in the present embodiment of the application. Optionally, the method may be achieved by a battery charging control system, in which the battery charging control system may be integrated in an intelligent charging apparatus (such as a charger), or it may be separate from the intelligent charging apparatus, or it may also be a local server or a cloud server used for processing the battery charging control process, which is not limited in the present embodiment of the application. As shown in FIG. 5, the method of intelligent charging control for an automotive battery may include steps as follows.

At step 201, identifying a battery parameter of the automotive battery to be charged.

At step 202, identifying a charging mode corresponding to the automotive battery based on the battery parameter of the automotive battery.

At step 203, identifying a present electrical parameter of the automotive battery, and identifying a charging phase of the charging mode corresponding to the automotive battery based on the present electrical parameter of the automotive battery.

At step 204, identifying a first repair charging control parameter of a fourth constant-current charging phase corresponding to the automotive battery when the charging mode is identified as the repair charging mode and the charging phase of the repair charging mode is the fourth constant-current charging phase, and performing a fifth constant-current charging control operation on the automotive battery based on the first repair charging control parameter; determining whether a present charging voltage of the automotive battery is greater than or equal to a preset first repair voltage parameter threshold during a process of performing the fifth constant-current charging control operation on the automotive battery; when a corresponding determination result is positive, converting the charging phase of the repair charging mode from the fourth constant-current charging phase to a third optimization charging phase.

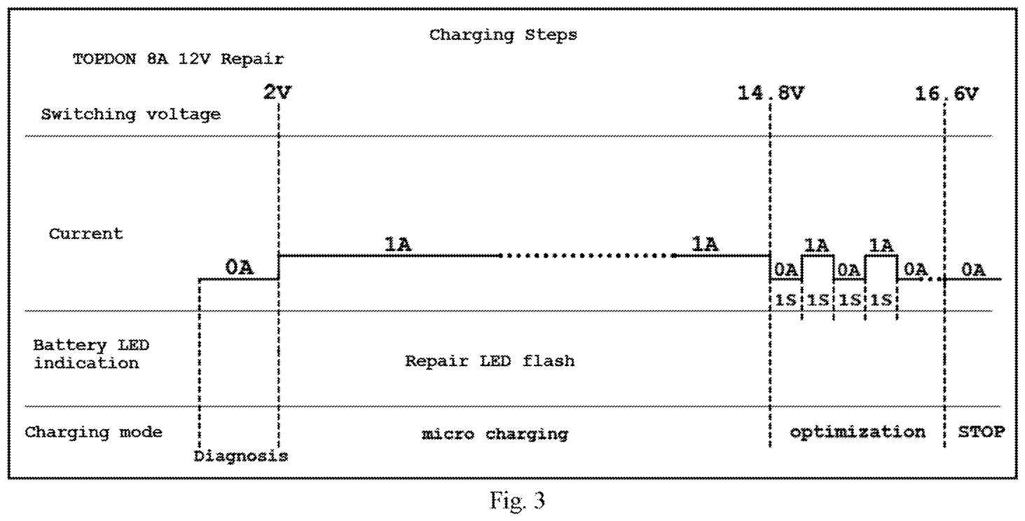

In the present embodiment of the application, as shown in FIG. 3, FIG. 3 is a flow diagram of automotive battery charging control of the repair charging mode disclosed in the embodiments of the present application, in which micro charging indicates the fourth constant-current charging phase, and optimization indicates the third optimization charging phase. Optionally, as shown in FIG. 3, the first repair charging control parameter includes a seventh constant-current electrical parameter.

At step 205, identifying a second repair charging control parameter of the third optimization charging phase corresponding to the automotive battery when the charging mode is identified as the repair charging mode and the charging phase of the repair charging mode is the third optimization charging phase, and performing a second pulse charging control operation on the automotive battery based on the second repair charging control parameter; determining whether a present charging voltage of the automotive battery is greater than or equal to a preset second repair voltage parameter threshold during a process of performing the second pulse charging control operation on the automotive battery; when a corresponding determination result is positive, performing a stop-charging control operation on the automotive battery.

In the embodiment of the present application, when the automotive battery suffers from battery capacity loss or other loss conditions, the charging mode corresponding to the automotive battery is identified to be the repair charging mode. Optionally, as shown in FIG. 3, the second repair charging control parameter includes a second duty ratio parameter, a second pulse cycle parameter and a second pulse electrical parameter. For example, as shown in FIG. 3, i.e., when the automotive battery is in the third optimization charging phase, a pulse charging control operation may be adopted with a duty ratio of 50%, a pulse current parameter of 1 A and a pulse cycle parameter of 2s. Further and optionally, for the automotive battery requiring for repair, similarly, the voltage parameter range corresponding to the present charging phase and the required related charging electrical parameters of the automotive battery may also be determined based on specific rated electrical parameters, the standard voltage parameter range under each charging phase of a standard automotive battery with a rated current of 8 A and a rated voltage of 12V as shown in FIG. 3, and the proportion between the required standard related charging electrical parameters.

In the present embodiment of the application, of other descriptions of step 201 to step 203, please refer to the detailed descriptions for step 101 to step 103 in embodiment 1, which is not repeated in the present embodiment of the application.

It is to be seen that, by implement the present embodiment of the application, the related charging control parameter may be identified of the fourth constant-current charging phase and the third optimization charging phase of the automotive battery requiring for repair, so as to implement a repair charging control operation on the automotive battery. In such a setup, it may improve the reliability and accuracy of repair charging control in the fourth constant-current charging phase and the third optimization charging phase of the automotive battery, which may effectively repair the loss of the battery, thereby ensuring an overall charging performance of the battery. Meanwhile, the related charging electrical parameter of each charging phase may be adjusted of different rated electrical parameters of the battery requiring for repair, which facilitates to improve the repair charging compatibility between the charging device and the battery requiring for repair, so that it facilitates to improve the repair charging matching between the charging device and the battery requiring for repair, thereby facilitating to improve an overall repair charging performance of the charging device for the battery.

In an optional embodiment, before the step 203 mentioned above of identifying a present electrical parameter of the automotive battery, and identifying a charging phase of the charging mode corresponding to the automotive battery, the method also includes:
identifying a present status parameter of the automotive battery;
determining whether the present status parameter satisfies a preset battery charging condition based on the present status parameter of the automotive battery; and
when the determination result is positive, triggering the implementation of step 203 mentioned above of identifying a present electrical parameter of the automotive battery, and identifying a charging phase of the charging mode corresponding to the automotive battery.

In the present optional embodiment, optionally, the present status parameter includes at least one of a present access status parameter, a present circuit status parameter, a present battery temperature parameter and a present voltage parameter, in which the present access status parameter may be understood as the access mode of the automotive battery, and the present circuit status parameter may be understood as the short-circuit condition of the automotive battery. Specifically, determination of whether the present state parameters satisfy the preset battery charging conditions may be to determine whether there is a reverse connection of the access mode of the automobile battery, whether there is a short circuit in the present circuit of the automobile battery, whether there is overheating in the present battery temperature of the automobile battery, whether there is over voltage in the present voltage of the automobile battery, etc. If the above conditions do not exist, it is confirmed that the present state parameters satisfy the preset battery charging conditions, and if the above conditions exist, a warning prompt is output to indicate the user to deal with the above conditions.

It is to be seen that, by adopting the present optional embodiment, determination of whether the present state parameters of the automotive battery meet the preset battery charging conditions is performed before implement a charging control operation on the automotive battery. In such a setup, it facilitates to improve the reliability and accuracy of triggering the charging control operation on the automotive battery, which facilitates to improve the effectiveness of the charging control operation of the automotive battery, thereby achieving the required charging performance of the automotive battery.

### Embodiment 3

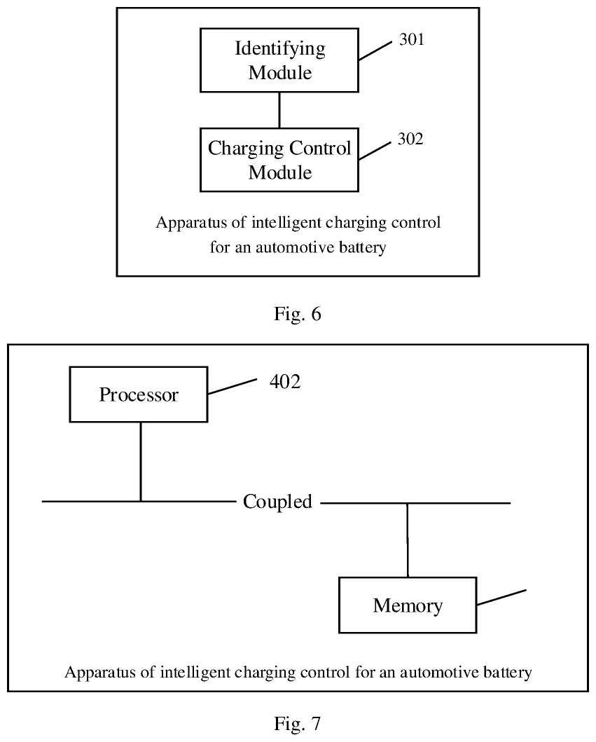

Referring to FIG. 6, FIG. 6 is a structural diagram of an apparatus of intelligent charging control for an automotive battery disclosed in the embodiments of the present application. As shown in FIG. 6, the apparatus of intelligent charging control for an automotive battery may include:
an identifying module 301, used for identifying the battery parameter of the automotive battery to be charged, identifying a charging mode corresponding to the automotive battery based on the battery parameter of the automotive battery, identifying a present electrical parameter of the automotive battery, and identifying a charging phase of the charging mode corresponding to the automotive battery based on the present electrical parameter of the automotive battery; and
a charging control module 302, used for identifying a target charging control parameter of the charging phase corresponding to the automotive battery based on the charging phase of the charging mode corresponding to the automotive battery, and performing a charging control operation on the automotive battery based on the target charging control parameter.

In the present embodiment of the application, the battery parameter of the automotive battery includes at least one of a rated electrical parameter, a battery type parameter, a charging environment parameter and a battery loss condition. The charging mode corresponding to the automotive battery is one of a first charging mode, a second charging mode, a cold environment charging mode, a lithium battery charging mode and a repair charging mode. Additionally, the first charging mode, the second charging mode and the cold environment charging mode all belong to a target charging mode corresponding to the automotive battery.

It is to be seen that implementation of the apparatus of intelligent charging control for an automotive battery described as FIG. 6 enables intelligent charging of an automotive battery through multiple charging modes and multiple charging phases. In such a setup, by improving the charging compatibility between the charger and the battery, it may not only improve the charging matching between the charger and the battery, but also may improve the charging accuracy of the battery, so that the occurrence of the battery being undercharged or float charging is decreased, thereby improving the charging performance of the battery to ensure a normal operation of a car.

In an optional embodiment, steps of the charging control module 302 identifying a target charging control parameter of the charging phase corresponding to the automotive battery based on the charging phase of the charging mode corresponding to the automotive battery, and performing a charging control operation on the automotive battery based on the target charging control parameter, specifically include:
identifying a first charging control parameter of a desulphation charging phase corresponding to the automotive battery when the charging mode is identified as one of the target charging modes and the charging phase of the target charging mode is identified as a desulphation charging phase, and performing a first pulse charging control operation on the automotive battery based on the first charging control parameter; determining whether a present charging voltage of the automotive battery is greater than or equal to a preset first voltage parameter threshold during a process of performing a first pulse charging control operation on the automotive battery; when a corresponding determination result is positive, converting the charging phase of the target charging mode from the desulphation charging phase to a pre-charge charging phase; and
identifying a second charging control parameter of the pre-charge charging phase corresponding to the automotive battery when the charging mode is identified as one of the target charging modes and the charging phase of the target charging mode is identified as the pre-charge charging phase, and performing a first constant-current charging control operation on the automotive battery based on the second charging control parameter; determining whether the present charging voltage of the automotive battery is greater than or equal to a preset second voltage parameter threshold during a process of performing a first constant-current charging control operation on the automotive battery; when a corresponding determination result is positive, converting the charging phase of the target charging mode from the pre-charge charging phase to a first soft start charging phase.

In the present optional embodiment, the first charging control parameter includes a first duty ratio parameter, a first pulse cycle parameter and a first pulse electrical parameter, and the second charging control parameter includes a first constant-current electrical parameter.

It is to be seen that, by implementing the apparatus of intelligent charging control for an automotive battery described as FIG. 6, the related charging control parameter may be identified of the desulphation charging phase and the pre-charge charging phase of the automotive battery so as to implement the charging control operation on the automotive battery. In such a setup, it may improve the reliability and accuracy of the charging control in the desulphation charging phase and the pre-charge charging phase of the automotive battery, so that the occurrence of the battery being undercharged or float charging is decreased through the battery activation, thereby improving the charging performance of the battery. Meanwhile, the related charging electrical parameter of each charging phase may be adjusted of different rated electrical parameters of the battery, which facilitates to improve the charging compatibility between the charging device and the battery, so that it facilitates to improve the charging matching between the charging device and the battery, thereby facilitating to improve an overall charging performance of the charging device for the battery.

In an optional embodiment, steps of the charging control module 302 identifying a target charging control parameter of the charging phase corresponding to the automotive battery based on the charging phase of the charging mode corresponding to the automotive battery, and performing a charging control operation on the automotive battery based on the target charging control parameter, specifically also include:
identifying a third charging control parameter of the first soft start charging phase corresponding to the automotive battery when the charging mode is identified as one of the target charging modes and the charging phase of the target charging mode is identified as the first soft start charging phase, and performing a first stepped charging control operation on the automotive battery based on the third charging control parameter; determining whether the present charging voltage of the automotive battery is greater than or equal to a preset third voltage parameter threshold during a process of performing a first stepped charging control operation on the automotive battery; when a corresponding determination result is positive, converting the charging phase of the target charging mode from the first soft start charging phase to a first constant-current charging phase;
identifying a fourth charging control parameter of the first constant-current charging phase corresponding to the automotive battery when the charging mode is identified as one of the target charging modes and the charging phase of the charging mode is the first constant-current charging phase, and performing a second constant-current charging control operation on the automotive battery based on the fourth charging control parameter; determining whether the present charging voltage of the automotive battery is greater than or equal to a preset fourth voltage parameter threshold during a process of performing a second constant-current charging control operation on the automotive battery; when a corresponding determination result is positive, converting the charging phase of the target charging mode from the first constant-current charging phase to a first optimization charging phase; and
identifying a fifth charging control parameter of the first optimization charging phase corresponding to the automotive battery when the charging mode is identified as one of the target charging modes and the charging phase of the charging mode is the first optimization charging phase, and performing a first optimization charging control operation on the automotive battery based on the fifth charging control parameter; determining whether a present first charging parameter of the automotive battery satisfies a preset trickle-charging converting condition during a process of performing the first optimization charging control operation on the automotive battery; when a corresponding determination result is positive, converting the charging phase of the target charging mode from the first optimization charging phase to a trickle charging phasc.

In the present optional embodiment, the third charging control parameter includes a first stepped electrical parameter and a first stepped charging time parameter, the fourth charging control parameter includes a second constant-current electrical parameter, and the fifth charging control parameter includes at least one of a first current declining parameter, a second stepped electrical parameter and a second stepped charging time parameter.

It is to be seen that, by implementing the apparatus of intelligent charging control for an automotive battery described as FIG. 6, the related charging control parameter may be identified of the first soft start charging phase, the first constant-current charging phase and the first optimization charging phase of the automotive battery to implement the charging control operation on the automotive battery. In such a setup, it improves the reliability and accuracy of charging control operation on the first soft start charging phase, the first constant-current charging phase, and the first optimization charging phase of the automotive battery, so that a fully charging of the battery is achieved to decrease the occurrence of float charging or insufficient charging of batteries, thereby improving the charging performance of the battery to ensure a smooth launching of a car.

In an optional embodiment, steps of the charging control module 302 identifying a target charging control parameter of the charging phase corresponding to the automotive battery based on the charging phase of the charging mode corresponding to the automotive battery, and performing a charging control operation on the automotive battery based on the target charging control parameter, specifically also include:
identifying a sixth charging control parameter of the trickle charging phase corresponding to the automotive battery when the charging mode is identified as one of the target charging modes and the charging phase of the charging mode is the trickle charging phase, and performing a trickle charging control operation on the automotive battery based on the sixth charging control parameter; determining whether the present charging voltage of the automotive battery is greater than or equal to a preset fifth voltage parameter threshold during a process of performing the trickle charging control operation on the automotive battery; when a corresponding determination result is positive, converting the charging phase of the target charging mode from the trickle charging phase to an analysis charging phase;
performing a suspend charging control operation on the automotive battery when the charging mode is identified as one of the target charging modes and the charging phase of the charging mode is the analysis charging phase; determining whether the present charging voltage of the automotive battery is smaller than or equal to a preset sixth voltage parameter threshold during a process of performing the suspend charging control operation on the automotive battery; when a corresponding determination result is positive, converting the charging phase of the target charging mode from the analysis charging phase to a maintain charging phase;
identifying a seventh charging control parameter of the maintain charging phase corresponding to the automotive battery when the charging mode is identified as one of the target charging modes and the charging phase of the charging mode is the maintain charging phase, and performing a maintain charging control operation on the automotive battery based on the seventh charging control parameter; determining whether the present charging voltage of the automotive battery is greater than or equal to a preset seventh voltage parameter threshold during a process of performing the maintain charging control operation on the automotive battery; when a corresponding determination result is positive, detecting whether the automotive battery is in a access charging status, and if yes, converting the charging phase of the target charging mode from the maintain charging phase to the analysis charging phase.

In the present optional embodiment, the sixth charging control parameter includes a third constant-current electrical parameter, and the seventh charging control parameter includes a fourth constant-current electrical parameter.

It is to be seen that, by implementing the apparatus of intelligent charging control for an automotive battery described as FIG. 6, the related charging control parameter may be identified of the trickle charging phase, the analysis charging phase and the maintain charging phase of the automotive battery, so as to implement a charging control operation on the automotive battery, which is achieved that the charging phases of automotive battery may be converted intelligently. In such a setup, it may improve the reliability and the accuracy of charging control during the trickle charging phase, the analysis charging phase and the maintain charging phase of the battery, which may effectively decrease the occurrence of float charging or insufficient charging of batteries, so as to improve the charging performance of the battery, thereby improving the user stickiness of the charging device.

In an optional embodiment, steps of the charging control module 302 identifying a target charging control parameter of the charging phase corresponding to the automotive battery based on the charging phase of the charging mode corresponding to the automotive battery, and performing a charging control operation on the automotive battery based on the target charging control parameter, specifically include:
identifying a first lithium battery charging control parameter of a second constant-current charging phase corresponding to the automotive battery when the charging mode is identified as the lithium battery charging mode and the charging phase of the lithium battery charging mode is the second constant-current charging phase, and performing a third constant-current charging control operation on the automotive battery based on the first lithium battery charging control parameter; determining whether a present charging voltage of the automotive battery is greater than or equal to a preset first lithium-battery-voltage-parameter threshold during a process of performing the third constant-current charging control operation on the automotive battery; when a corresponding determination result is positive, converting the charging phase of the lithium battery charging mode from the second constant-current charging phase to a second soft start charging phase; and
identifying a second lithium battery charging control parameter of the second soft start charging phase corresponding to the automotive battery when the charging mode is identified as the lithium battery charging mode and the charging phase of the lithium battery charging mode is the second soft start charging phase, and performing a second stepped charging control operation on the automotive battery based on the second lithium battery charging control parameter; determining whether the present charging voltage of the automotive battery is greater than or equal to a preset second lithium-battery-voltage-parameter threshold during a process of performing the second stepped charging control operation on the automotive battery; when a corresponding determination result is positive, converting the charging phase of the lithium battery charging mode from the second soft start charging phase to a third constant-current charging phase.

In the present optional embodiment, the first lithium battery charging control parameter includes a fifth constant-current electrical parameter, and the second lithium battery charging control parameter includes a third stepped electrical parameter and a third stepped charging time parameter.

It is to be seen that, by implementing the apparatus of intelligent charging control for an automotive battery described as FIG. 6, the related charging control parameter may be identified of the second constant-current charging phase and the second soft start charging phase of the automotive battery of lithium type, so as to implement a charging control operation on the automotive battery. In such a setup, it may improve the reliability and accuracy of charging control in the second constant-current charging phase and the second soft start charging phase of the automotive battery, so as to decrease the occurrence of float charging or insufficient charging of batteries, thereby improving the charging performance of the battery. Meanwhile, the related charging electrical parameter of each charging phase may be adjusted of different rated electrical parameters of the lithium battery, which facilitates to improve the charging compatibility between the charging device and the lithium battery, so that it facilitates to improve the charging matching between the charging device and the lithium battery, thereby facilitating to improve an overall charging performance of the charging device for the battery.

In an optional embodiment, steps of the charging control module 302 identifying a target charging control parameter of the charging phase corresponding to the automotive battery based on the charging phase of the charging mode corresponding to the automotive battery, and performing a charging control operation on the automotive battery based on the target charging control parameter, specifically also include:
identifying a third lithium battery charging control parameter of the third constant-current charging phase corresponding to the automotive battery when the charging mode is identified as the lithium battery charging mode and the charging phase of the lithium battery charging mode is the third constant-current charging phase, and performing a fourth constant-current charging control operation on the automotive battery based on the third lithium battery charging control parameter; determining whether the present charging voltage of the automotive battery is greater than or equal to a preset third lithium-battery-voltage-parameter threshold during a process of performing the fourth constant-current charging control operation on the automotive battery; when a corresponding determination result is positive, converting the charging phase of the lithium battery charging mode from the third constant-current charging phase to a second optimization charging phase, in which the third lithium battery charging control parameter includes a sixth constant-current electrical parameter; and
identifying a fourth lithium battery charging control parameter of the second optimization charging phase corresponding to the automotive battery when the charging mode is identified as the lithium battery charging mode and the charging phase of the lithium battery charging mode is the second optimization charging phase, and performing a second optimization charging control operation on the automotive battery based on the fourth lithium battery charging control parameter; determining whether a present second charging parameter of the automotive battery satisfies a preset stop-charging condition during a process of performing the second optimization charging control operation on the automotive battery; when a corresponding determination result is positive, performing a stop-charging control operation on the automotive battery.

In the present optional embodiment, the third lithium battery charging control parameter includes a sixth constant-current electrical parameter, and the fourth lithium battery charging control parameter includes at least one of a second current declining parameter, a fourth stepped electrical parameter and a fourth stepped charging time parameter.

It is to be seen that, by implementing the apparatus of intelligent charging control for an automotive battery described as FIG. 6, the related charging control parameter may be identified of the third constant-current charging phase and the second optimization charging phase of the automotive battery of lithium type, so as to implement a charging control operation on the automotive battery. In such a setup, while improving the compatibility of the charging device for the automotive battery, it may improve the reliability and accuracy of charging control in the third constant-current charging phase and the second optimization charging phase of the automotive battery of lithium type, so that a fully charging of the lithium battery is achieved to decrease the occurrence of float charging or insufficient charging of batteries, thereby improving the charging performance of the lithium battery to ensure a smooth launching of a car.

In an optional embodiment, steps of the charging control module 302 identifying a target charging control parameter of the charging phase corresponding to the automotive battery based on the charging phase of the charging mode corresponding to the automotive battery, and performing a charging control operation on the automotive battery based on the target charging control parameter, specifically include:
identifying a first repair charging control parameter of a fourth constant-current charging phase corresponding to the automotive battery when the charging mode is identified as the repair charging mode and the charging phase of the repair charging mode is the fourth constant-current charging phase, and performing a fifth constant-current charging control operation on the automotive battery based on the first repair charging control parameter; determining whether a present charging voltage of the automotive battery is greater than or equal to a preset first repair voltage parameter threshold during a process of performing the fifth constant-current charging control operation on the automotive battery; when a corresponding determination result is positive, converting the charging phase of the repair charging mode from the fourth constant-current charging phase to a third optimization charging phase; and
identifying a second repair charging control parameter of the third optimization charging phase corresponding to the automotive battery when the charging mode is identified as the repair charging mode and the charging phase of the repair charging mode is the third optimization charging phase, and performing a second pulse charging control operation on the automotive battery based on the second repair charging control parameter; determining whether a present charging voltage of the automotive battery is greater than or equal to a preset second repair voltage parameter threshold during a process of performing the second pulse charging control operation on the automotive battery; when a corresponding determination result is positive, performing a stop-charging control operation on the automotive battery.

In the present optional embodiment, the first repair charging control parameter includes a seventh constant-current electrical parameter; and the second repair charging control parameter includes a second duty ratio parameter, a second pulse cycle parameter and a second pulse electrical parameter.

It is to be seen that, by implementing the apparatus of intelligent charging control for an automotive battery described as FIG. 6, the related charging control parameter may be identified of the fourth constant-current charging phase and the third optimization charging phase of the automotive battery requiring for repair, so as to implement a repair charging control operation on the automotive battery. In such a setup, it may improve the reliability and accuracy of repair charging control in the fourth constant-current charging phase and the third optimization charging phase of the automotive battery, which may effectively repair the loss of the battery, thereby ensuring an overall charging performance of the battery. Meanwhile, the related charging electrical parameter of each charging phase may be adjusted of different rated electrical parameters of the battery requiring for repair, which facilitates to improve the repair charging compatibility between the charging device and the battery requiring for repair, so that it facilitates to improve the repair charging matching between the charging device and the battery requiring for repair, thereby facilitating to improve an overall repair charging performance of the charging device for the battery.

### Embodiment 4

Referring to FIG. 7, FIG. 7 is a structural diagram of another apparatus of intelligent charging control for an automotive battery disclosed in the embodiments of the present application. As shown in FIG. 7, the apparatus of intelligent charging control for an automotive battery may include:
a memory 401, memorized with an executable code, and
a processor 402, coupled with the memory 401,
in which the processor 402 invokes the executable code memorized in the memory 401 to perform steps of the method of intelligent charging control for an automotive battery described in the embodiment 1 and embodiment 2 of the present application.

### Embodiment 5

Disclosed in the present embodiment of the application is a non-transitory computer memory medium, the non-transitory computer memory medium memorizes computer instructions; when the computer instructions are invoked, steps of the method of intelligent charging control for an automotive battery described in the embodiment 1 and embodiment 2 of the present application are performed.

### Embodiment 6

Disclosed in the present embodiment of the application is a computer program product, the computer program product includes a non-instantaneous computer readable memory medium that stores a computer program, and the computer program are invoked to implement steps of the method of intelligent charging control for an automotive battery described in the embodiment 1 and embodiment 2 of the present application.

It is only schematic to describe the aforementioned embodiment of the apparatus. The modules described as separate components may or may not be physically separated, and the modules used as components for display may or may not be physical modules, that is, they may be located in the same place or may be distributed to a plurality of network modules. Some or all these modules may be selected according to practical demands to achieve the purpose of the solution of the present embodiment. It may be understood and implemented by a person of ordinary skill in the art without inventive effort.

With the specific description of the above embodiments, it is clear to those skilled in the art that the various implementations may be implemented with the aid of software plus the necessary common hardware platform, and of course, with the aid of hardware. Based on this understanding, the above technical solutions that essentially or contribute to the prior art may be embodied in the form of a software product which may be memorized in a computer-readable memory medium, the memory medium including Read-Only Memory, Random Access Memory, Programmable Read-only Memory, Erasable Programmable Read Only Memory, One-time Programmable Read-Only Memory, Electrically-Erasable Programmable Read-Only Memory, Compact Disc Read-Only Memory, other Compact Disc Memory, Disk Memory, Tape Memory or any other computer-readable medium that may be used to carry or memorize data.

Finally, it should be noted that the method and apparatus of intelligent charging control for an automotive battery disclosed in the embodiments of the present application are only preferred embodiments of the present application, and are only used to illustrate the technical solutions of the present application, but not to limit them. Despite the detailed description of the application with reference to the aforementioned embodiments, it should be understood, by those skilled in the art, that the technical solutions recorded in the aforementioned embodiments may still be modified, or equivalent substitutions for some of the technical features thereof may be made; which the essence of the corresponding technical solutions of these modifications or substitutions is without departing from the spirit and scope of the technical solutions of the various embodiments of the application.

1. A method of intelligent charging control for an automotive battery, characterized by comprising:
identifying a battery parameter of the automotive battery to be charged, the battery parameter of the automotive battery comprising at least one of a rated electrical parameter, a battery type parameter, a charging environment parameter and a battery loss condition;
identifying a charging mode corresponding to the automotive battery based on the battery parameter of the automotive battery, wherein the charging mode corresponding to the automotive battery is one of a first charging mode, a second charging mode, a cold environment charging mode, a lithium battery charging mode and a repair charging mode; additionally, the first charging mode, the second charging mode and the cold environment charging mode all belong to a target charging mode corresponding to the automotive battery;
identifying a present electrical parameter of the automotive battery, and identifying a charging phase of the charging mode corresponding to the automotive battery based on the present electrical parameter of the automotive battery; and
identifying a target charging control parameter of the charging phase corresponding to the automotive battery based on the charging phase of the charging mode corresponding to the automotive battery, and performing a charging control operation on the automotive battery based on the target charging control parameter.

2. The method of intelligent charging control for an automotive battery according to claim 1, characterized in that steps of identifying a target charging control parameter of the charging phase corresponding to the automotive battery based on the charging phase of the charging mode corresponding to the automotive battery, and performing the charging control operation on the automotive battery based on the target charging control parameter, comprises:
identifying a first charging control parameter of a desulphation charging phase corresponding to the automotive battery when the charging mode is identified as one of the target charging modes and the charging phase of the target charging mode is identified as a desulphation charging phase, and performing a first pulse charging control operation on the automotive battery based on the first charging control parameter; determining whether a present charging voltage of the automotive battery is greater than or equal to a preset first voltage parameter threshold during a process of performing the first pulse charging control operation on the automotive battery; when a corresponding determination result is positive, converting the charging phase of the target charging mode from the desulphation charging phase to a pre-charge charging phase, wherein the first charging control parameter comprises a first duty ratio parameter, a first pulse cycle parameter and a first pulse electrical parameter; and
identifying a second charging control parameter of the pre-charge charging phase corresponding to the automotive battery when the charging mode is identified as one of the target charging modes and the charging phase of the target charging mode is identified as the pre-charge charging phase, and performing a first constant-current charging control operation on the automotive battery based on the second charging control parameter; determining whether the present charging voltage of the automotive battery is greater than or equal to a preset second voltage parameter threshold during a process of performing the first constant-current charging control operation on the automotive battery; when a corresponding determination result is positive, converting the charging phase of the target charging mode from the pre-charge charging phase to a first soft start charging phase, wherein the second charging control parameter comprises a first constant-current electrical parameter.

3. The method of intelligent charging control for an automotive battery according to claim 2, characterized in that the method also comprises:
identifying a third charging control parameter of the first soft start charging phase corresponding to the automotive battery when the charging mode is identified as one of the target charging modes and the charging phase of the target charging mode is identified as the first soft start charging phase, and performing a first stepped charging control operation on the automotive battery based on the third charging control parameter; determining whether the present charging voltage of the automotive battery is greater than or equal to a preset third voltage parameter threshold during a process of performing the first stepped charging control operation on the automotive battery; when a corresponding determination result is positive, converting the charging phase of the target charging mode from the first soft start charging phase to a first constant-current charging phase, wherein the third charging control parameter comprises a first stepped electrical parameter and a first stepped charging time parameter;
identifying a fourth charging control parameter of the first constant-current charging phase corresponding to the automotive battery when the charging mode is identified as one of the target charging modes and the charging phase of the charging mode is identified as the first constant-current charging phase, and performing a second constant-current charging control operation on the automotive battery based on the fourth charging control parameter; determining whether the present charging voltage of the automotive battery is greater than or equal to a preset fourth voltage parameter threshold during a process of performing the second constant-current charging control operation on the automotive battery: when a corresponding determination result is positive, converting the charging phase of the target charging mode from the first constant-current charging phase to a first optimization charging phase, wherein the fourth charging control parameter comprises a second constant-current electrical parameter; and
identifying a fifth charging control parameter of the first optimization charging phase corresponding to the automotive battery when the charging mode is identified as one of the target charging modes and the charging phase of the charging mode is identified as the first optimization charging phase, and performing a first optimization charging control operation on the automotive battery based on the fifth charging control parameter; determining whether a present first charging parameter of the automotive battery satisfies a preset trickle-charging converting condition during a process of performing the first optimization charging control operation on the automotive battery; when a corresponding determination result is positive, converting the charging phase of the target charging mode from the first optimization charging phase to a trickle charging phase, wherein the fifth charging control parameter comprises at least one of a first current declining parameter, a second stepped electrical parameter and a second stepped charging time parameter.

4. The method of intelligent charging control for an automotive battery according to claim 3, characterized in that the method also comprises:
identifying a sixth charging control parameter of the trickle charging phase corresponding to the automotive battery when the charging mode is identified as one of the target charging modes and the charging phase of the charging mode is identified as the trickle charging phase, and performing a trickle charging control operation on the automotive battery based on the sixth charging control parameter; determining whether the present charging voltage of the automotive battery is greater than or equal to a preset fifth voltage parameter threshold during a process of performing the trickle charging control operation on the automotive battery; when a corresponding determination result is positive, converting the charging phase of the target charging mode from the trickle charging phase to an analysis charging phase, wherein the sixth charging control parameter comprises a third constant-current electrical parameter;
performing a suspend charging control operation on the automotive battery when the charging mode is identified as one of the target charging modes and the charging phase of the charging mode is identified as the analysis charging phase; determining whether the present charging voltage of the automotive battery is smaller than or equal to a preset sixth voltage parameter threshold during a process of performing the suspend charging control operation on the automotive battery; when a corresponding determination result is positive, converting the charging phase of the target charging mode from the analysis charging phase to a maintain charging phase; and
identifying a seventh charging control parameter of the maintain charging phase corresponding to the automotive battery when the charging mode is identified as one of the target charging modes and the charging phase of the charging mode is identified as the maintain charging phase, and performing a maintain charging control operation on the automotive battery based on the seventh charging control parameter; determining whether the present charging voltage of the automotive battery is greater than or equal to a preset seventh voltage parameter threshold during a process of performing the maintain charging control operation on the automotive battery; when a corresponding determination result is positive, detecting whether the automotive battery is in a access charging status, and if yes, converting the charging phase of the target charging mode from the maintain charging phase to the analysis charging phase, wherein the seventh charging control parameter comprises a fourth constant-current electrical parameter.

5. The method of intelligent charging control for an automotive battery according to claim 1, characterized in that steps of identifying a target charging control parameter of the charging phase corresponding to the automotive battery based on the charging phase of the charging mode corresponding to the automotive battery, and performing the charging control operation on the automotive battery based on the target charging control parameter, comprises:
identifying a first lithium battery charging control parameter of a second constant-current charging phase corresponding to the automotive battery when the charging mode is identified as the lithium battery charging mode and the charging phase of the lithium battery charging mode is identified as the second constant-current charging phase, and performing a third constant-current charging control operation on the automotive battery based on the first lithium battery charging control parameter; determining whether a present charging voltage of the automotive battery is greater than or equal to a preset first lithium-battery-voltage-parameter threshold during a process of performing the third constant-current charging control operation on the automotive battery; when a corresponding determination result is positive, converting the charging phase of the lithium battery charging mode from the second constant-current charging phase to a second soft start charging phase, wherein the first lithium battery charging control parameter comprises a fifth constant-current electrical parameter; and
identifying a second lithium battery charging control parameter of the second soft start charging phase corresponding to the automotive battery when the charging mode is identified as the lithium battery charging mode and the charging phase of the lithium battery charging mode is identified as the second soft start charging phase, and performing a second stepped charging control operation on the automotive battery based on the second lithium battery charging control parameter; determining whether the present charging voltage of the automotive battery is greater than or equal to a preset second lithium-battery-voltage-parameter threshold during a process of performing the second stepped charging control operation on the automotive battery; when a corresponding determination result is positive, converting the charging phase of the lithium battery charging mode from the second soft start charging phase to a third constant-current charging phase, wherein the second lithium battery charging control parameter comprises a third stepped electrical parameter and a third stepped charging time parameter.

6. The method of intelligent charging control for an automotive battery according to claim 5, characterized in that the method also comprises:
identifying a third lithium battery charging control parameter of the third constant-current charging phase corresponding to the automotive battery when the charging mode is identified as the lithium battery charging mode and the charging phase of the lithium battery charging mode is identified as the third constant-current charging phase, and performing a fourth constant-current charging control operation on the automotive battery based on the third lithium battery charging control parameter; determining whether the present charging voltage of the automotive battery is greater than or equal to a preset third lithium-battery-voltage-parameter threshold during a process of performing the fourth constant-current charging control operation on the automotive battery; when a corresponding determination result is positive, converting the charging phase of the lithium battery charging mode from the third constant-current charging phase to a second optimization charging phase, wherein the third lithium battery charging control parameter comprises a sixth constant-current electrical parameter; and
identifying a fourth lithium battery charging control parameter of the second optimization charging phase corresponding to the automotive battery when the charging mode is identified as the lithium battery charging mode and the charging phase of the lithium battery charging mode is identified as the second optimization charging phase, and performing a second optimization charging control operation on the automotive battery based on the fourth lithium battery charging control parameter; determining whether a present second charging parameter of the automotive battery satisfies a preset stop-charging condition during a process of performing the second optimization charging control operation on the automotive battery; when a corresponding determination result is positive, performing a stop-charging control operation on the automotive battery, wherein the fourth lithium battery charging control parameter comprises at least one of a second current declining parameter, a fourth stepped electrical parameter and a fourth stepped charging time parameter.

7. The method of intelligent charging control for an automotive battery according to claim 1, characterized in that steps of identifying a target charging control parameter of the charging phase corresponding to the automotive battery based on the charging phase of the charging mode corresponding to the automotive battery, and performing the charging control operation on the automotive battery based on the target charging control parameter, comprises:
identifying a first repair charging control parameter of a fourth constant-current charging phase corresponding to the automotive battery when the charging mode is identified as the repair charging mode and the charging phase of the repair charging mode is identified as the fourth constant-current charging phase, and performing a fifth constant-current charging control operation on the automotive battery based on the first repair charging control parameter; determining whether a present charging voltage of the automotive battery is greater than or equal to a preset first repair voltage parameter threshold during a process of performing the fifth constant-current charging control operation on the automotive battery; when a corresponding determination result is positive, converting the charging phase of the repair charging mode from the fourth constant-current charging phase to a third optimization charging phase, wherein the first repair charging control parameter comprises a seventh constant-current electrical parameter; and
identifying a second repair charging control parameter of the third optimization charging phase corresponding to the automotive battery when the charging mode is identified as the repair charging mode and the charging phase of the repair charging mode is identified as the third optimization charging phase, and performing a second pulse charging control operation on the automotive battery based on the second repair charging control parameter; determining whether a present charging voltage of the automotive battery is greater than or equal to a preset second repair voltage parameter threshold during a process of performing the second pulse charging control operation on the automotive battery; when a corresponding determination result is positive, performing a stop-charging control operation on the automotive battery, wherein the second repair charging control parameter comprises a second duty ratio parameter, a second pulse cycle parameter and a second pulse electrical parameter.

8. An apparatus of intelligent charging control for an automotive battery, characterized in that the apparatus comprises:
an identifying module, used for identifying a battery parameter of the automotive battery to be charged, the battery parameter of the automotive battery comprising at least one of a rated electrical parameter, a battery type parameter, a charging environment parameter and a battery loss condition; identifying a charging mode corresponding to the automotive battery based on the battery parameter of the automotive battery, wherein the charging mode corresponding to the automotive battery is one of a first charging mode, a second charging mode, a cold environment charging mode, a lithium battery charging mode and a repair charging mode; additionally, the first charging mode, the second charging mode and the cold environment charging mode all belong to a target charging mode corresponding to the automotive battery; identifying a present electrical parameter of the automotive battery, and identifying a charging phase of the charging mode corresponding to the automotive battery based on the present electrical parameter of the automotive battery; and
a charging control module, used for identifying a target charging control parameter of the charging phase corresponding to the automotive battery based on the charging phase of the charging mode corresponding to the automotive battery, and performing a charging control operation on the automotive battery based on the target charging control parameter.

9. An apparatus of intelligent charging control for an automotive battery, characterized in that the apparatus comprises:
a memory, memorized with an executable code, and
a processor, coupled with the memory,
wherein the processor invokes the executable code memorized in the memory to perform the method of intelligent charging control for an automotive battery as claimed in claim 1.

10. An apparatus of intelligent charging control for an automotive battery, characterized in that the apparatus comprises:
a memory, memorized with an executable code, and
a processor, coupled with the memory,
wherein the processor invokes the executable code memorized in the memory to perform the method of intelligent charging control for an automotive battery as claimed in claim 2.

11. An apparatus of intelligent charging control for an automotive battery, characterized in that the apparatus comprises:
a memory, memorized with an executable code, and
a processor, coupled with the memory,
wherein the processor invokes the executable code memorized in the memory to perform the method of intelligent charging control for an automotive battery as claimed in claim 3.

12. An apparatus of intelligent charging control for an automotive battery, characterized in that the apparatus comprises:
a memory, memorized with an executable code, and
a processor, coupled with the memory,
wherein the processor invokes the executable code memorized in the memory to perform the method of intelligent charging control for an automotive battery as claimed in claim 4.

13. An apparatus of intelligent charging control for an automotive battery, characterized in that the apparatus comprises:
a memory, memorized with an executable code, and
a processor, coupled with the memory,
wherein the processor invokes the executable code memorized in the memory to perform the method of intelligent charging control for an automotive battery as claimed in claim 5.

14. An apparatus of intelligent charging control for an automotive battery, characterized in that the apparatus comprises:
a memory, memorized with an executable code, and
a processor, coupled with the memory,
wherein the processor invokes the executable code memorized in the memory to perform the method of intelligent charging control for an automotive battery as claimed in claim 6.

15. A non-transitory computer memory medium, characterized in that the non-transitory computer memory medium memorizes computer instructions; when the computer instructions are invoked, the method of intelligent charging control for an automotive battery as claimed in claim 1 is performed.

16. A non-transitory computer memory medium, characterized in that the non-transitory computer memory medium memorizes computer instructions; when the computer instructions are invoked, the method of intelligent charging control for an automotive battery as claimed in claim 2 is performed.

17. A non-transitory computer memory medium, characterized in that the non-transitory computer memory medium memorizes computer instructions; when the computer instructions are invoked, the method of intelligent charging control for an automotive battery as claimed in claim 3 is performed.

18. A non-transitory computer memory medium, characterized in that the non-transitory computer memory medium memorizes computer instructions; when the computer instructions are invoked, the method of intelligent charging control for an automotive battery as claimed in claim 4 is performed.

19. A non-transitory computer memory medium, characterized in that the non-transitory computer memory medium memorizes computer instructions; when the computer instructions are invoked, the method of intelligent charging control for an automotive battery as claimed in claim 5 is performed.

20. A non-transitory computer memory medium, characterized in that the non-transitory computer memory medium memorizes computer instructions; when the computer instructions are invoked, the method of intelligent charging control for an automotive battery as claimed in claim 6 is performed.
